(19) United States
(12) Patent Application Publication
(10) Pub. No.: US 2007/0144075 A1
(43) Pub. Date: Jun. 28, 2007

(54) Chemical mechanical polishing particles and slurry and method of producing the same

(75) Inventors: Kon-Tsu Kin, Hsinchu (TW); Shu-Fei Chan, Hsinchu (TW); Hsu-Chuan Liu, Hsinchu (TW); Ming-Shih Tsai, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute, Hsinchu (TW)

(21) Appl. No.: 11/635,686

(22) Filed: Dec. 8, 2006

(30) Foreign Application Priority Data
Dec. 9, 2005 (TW) 94143490

(51) Int. Cl. B24D 3/02; B32B 1/00; B32B 18/00

(52) U.S. Cl. 51/298; 51/309; 428/403; 428/407

(57) ABSTRACT

In a method of producing chemical mechanical polishing particles and slurry, a type of organic nano particles are put in a reaction solution containing nano-scale cerium oxide; the nano-scale cerium oxide is assembled to outer surface of the organic nano particles due to electrostatic attraction among particles, so as to form chemical mechanical polishing particles having a cerium oxide shell. The chemical mechanical polishing particles having a cerium oxide shell are then used to produce chemical mechanical polishing slurry.

### FIELD OF THE INVENTION

The present invention relates to a polishing material and a method of producing the same, and more particularly to chemical mechanical polishing particles and slurry, and method of producing the same.

### BACKGROUND OF THE INVENTION

Semiconductor technologies have been constantly improved. For a semiconductor element to have increased useful volume, increasing demands for miniaturized and multilayered lead wires has resulted in more difficulties in the semiconductor manufacturing process. Compared to other conventional planarization techniques, chemical mechanical polishing (CMP) is more helpful in upgrading good yield due to its high performance in global planarization, and is therefore indispensable to existing semiconductor manufacturing process.

In the process of chemical mechanical polishing, there are many variables, such as polishing slurry, polishing pad, polishing machine design, and operating conditions for polishing, including revolving speed, flow speed, pressure applied to wafer, etc. Among others, polishing slurry has direct influence on the polishing effect. Generally, ceramic powder forms the major part of the slurry for CMP, and is a key substance for producing the mechanical abrasion effect. The ceramic powder has direct influence on the removal rate, the selection ratio, the wafer planarization in the polishing process, which further have influences on the lamination roughness and defect densities of the produced wafer. The features of ceramic powder, including the components, the particle size, the particle size distribution, the purity, and the crystal form of the powder, all have direct influences on the property of polishing slurry and the abrasion effect thereof.

Currently, polishing slurry consisting of inorganic ceramic particles is adopted by most domestic and foreign semiconductor plants in chemical mechanical polishing. The polishing particles may be generally divided into three types, namely, Silica, alumina and cerium oxide abrasive.

The silicon oxide abrasives may be produced by vapor synthesis (fumed silica) or liquid-phase synthesis. The silicon oxide polishing particles produced by liquid-phase synthesis may be further divided into two types, namely, precipitated silica and colloidal silica particles. Normally, the precipitated silica particles are obtained by synthesis of sodium silicate (NaSiO₂). While the degree of sodium ion contamination on colloidal silica polishing slurry produced through ion exchange is somewhat high, such contamination degree is still low compared to the polishing slurry containing precipitated silica. Therefore, the colloidal silica has always been used as the polishing particles for primary and secondary polishing of silicon wafer. The colloidal silica particles are spherical in shape and therefore not easy to scratch the wafer in the polishing process. However, the colloidal silica particles have the disadvantages of low polishing rate and high cost.

The alumina abrasives are generally used to polish metal layers, such as tungsten, copper, etc. However, the alumina has relatively high hardness and tends to scratch the wafer surface or have residual particles set in metal wires. The alumina is normally synthesized by solid-state reaction, liquid solution method, or sol-gel method. The alumina produced by solid-state reaction has advantageous low preparation cost, but disadvantageous low purity and large particle size. On the other hand, the alumina particles prepared from liquid solution method have high purity and small particle size, but tend to produce hard aggregate. In the sol-gel method, aluminum alkoxide is hydrolyzed in water solution, so that a precursor is prepared. The precursor is then subjected to condensation reaction and polymerization to form molecular groups, which are subjected to calcinations to obtain alumina particles.

On the surface of cerium oxide abrasive, there is a Lewis acid active site within which silica has high activity, and an oxygen bridging bonding may be formed between the cerium oxide particle and the Lewis acid active site. The cerium oxide polishing particles are particularly useful in the shallow trench isolation (STI) process to provide high selection ratio and sufficient polishing rate. By “high selection ratio”, it means the cerium oxide polishing particles have a silica removal rate higher than silicon nitride hard mask removal rate. However, the cerium for forming the cerium oxide polishing particles is a rare-earth element and is very expensive. Moreover, cerium oxide polishing particles have particle sizes generally larger than 100 nm, and are therefore less stable and tend to aggregate in water. For forming cerium oxide polishing slurry, it is necessary to add a dispersant and to adjust the pH value of the slurry to be within a neutral range, so as to avoid aggregated particles. In addition, the cerium oxide polishing particles have an excessively large specific gravity, and therefore do not easily suspend in a water solution. Precipitated cerium oxide polishing particles tend to clog pipes and filters when being transferred therethrough in the CMP process.

### SUMMARY OF THE INVENTION

A primary object of the present invention is to provide chemical mechanical polishing (CMP) particles and slurry, and a method of producing such CMP particles and slurry, in which nano polishing particles having a cerium oxide shell are formed and used to produce chemical mechanical polishing slurry.

The chemical mechanical polishing particle provided by the present invention consists of an organic nano particle and a cerium oxide shell. The cerium oxide shell is formed on an outer surface of the organic nano particle. Unlike the conventional inorganic polishing particles, the organic nano particles have some extent of elasticity, and therefore do not have the problem of scratching a wafer surface. On the other hand, the organic nano particles enable improved planarization in the chemical mechanical polishing process.

The method of producing chemical mechanical polishing particles according to the present invention includes the step of putting organic nanoparticles in a reaction solution containing nano-scale cerium oxide, so that the nano-scale cerium oxide is assembled to outer surfaces of the organic nano particles due to electrostatic attraction among particles to form the chemical mechanical polishing particles of the present invention.

The chemical mechanical polishing slurry of the present invention is composed of a surfactant and a plurality of chemical mechanical polishing particles. The chemical mechanical polishing particles consist of a type of organic nano particles, each of which has a cerium oxide shell formed on an outer surface thereof, and are dispersed in the surfactant.

The method of producing chemical mechanical polishing slurry according to the present invention includes the steps of putting organic nanoparticles in a reaction solution containing nano-scale cerium oxide, so that the nano-scale cerium oxide is assembled to outer surfaces of the organic nano particles due to electrostatic attraction among particles to form chemical mechanical polishing particles; separating the chemical mechanical polishing particles from most part of the reaction solution; and mixing the chemical mechanical polishing particles with a surfactant.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in the method of producing chemical mechanical polishing particles and slurry according to an embodiment of the present invention; and

FIG. 2 is a graph showing the selection ratio of the chemical mechanical polishing slurry with respect to silicon oxide and silicon nitride according to an embodiment of the present invention.

### DETAILED DESCRIPTION OF THE PREFERRED EMBODIMENTS

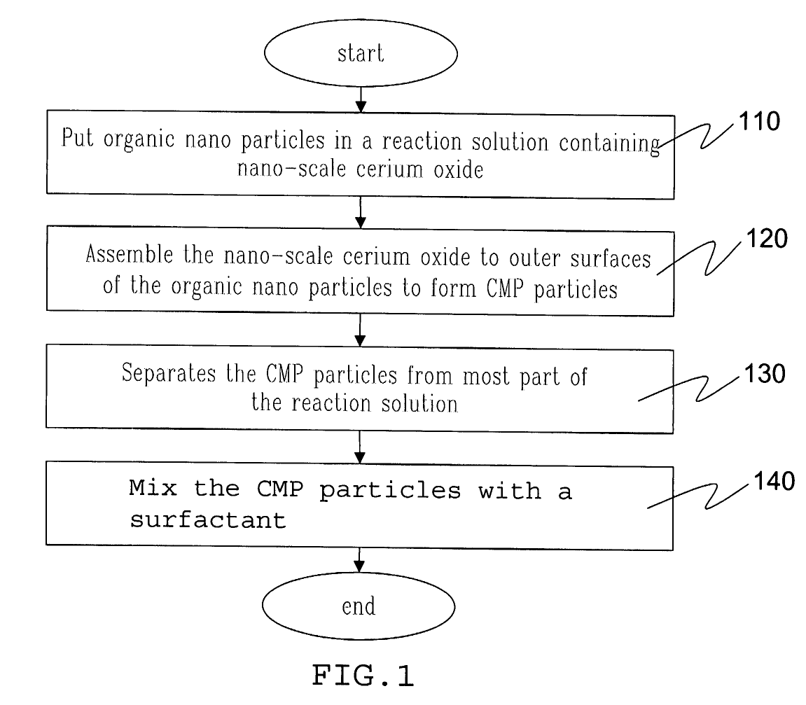

In a method for producing chemical mechanical polishing slurry according to an embodiment of the present invention, chemical mechanical polishing particles are formed first for synthesis of chemical mechanical polishing slurry. Please refer to FIG. 1 that is a flowchart showing the steps included in the method of producing chemical mechanical polishing slurry according to the present invention. As shown, in the first step 110, a type of organic nano particles is put in a reaction solution containing nano-scale cerium oxide. In the second step 120, the nano-scale cerium oxide is assembled to the surfaces of the organic nano particles due to an electrostatic attraction among particles, so as to form chemical mechanical polishing particles. In the third step 130, the chemical mechanical polishing particles are separated from most part of the reaction solution. In the last step 140, the separated chemical mechanical polishing particles are mixed with a surfactant.

Wherein, the organic nano particles are synthesized by way of emulsion polymerization. As an example, to produce nano-scale polystyrene particles, first add a surfactant into deionized water, so that the surfactant reaches its critical micelle concentration (CMC). Then, stir the solution for 1-2 hours. A preferred concentration for the surfactant is ranged between 0.4 CMC and 1 CMC. Then, add in an amount of styrene monomer, a preferred concentration for which is ranged between 0.4 and 0.8 mole concentration (M). The mixture is stirred at a uniform speed about 300 rpm to obtain an even mixing, so that the styrene monomer could enter into the micelles. Thereafter, the mixture is added with an amount of potassium persulfate (KPS) as an initiator, a concentration for which is ranged between 8 and 25 millimole (mM), and then subjected to polymerization at a constant temperature of 70° C. for 3 hours.

The surfactant used in the illustrated embodiment of the present invention is sodiumdodecyl sulfate (SDS). By taking advantage of the coexisted hydrophobic and hydrophilic structures of SDS and properly controlling the concentration thereof, the SDS may form micelles of specific size in the deionized water, and accordingly constitutes a micro-reactor, which forms a template to serve as a reaction chamber for organic polymerization. Then, non-polar styrene monomer is subjected to solubilization to enter into inner cores of the micelles. Thereafter, the initiator, that is, KPS, is added into the mixture for the monomer to polymerize and produce the nano-scale polystyrene particles.

The reaction solution containing nano-scale cerium oxide may be a cerium ammonium nitrite solution mixed with urea. In the illustrated embodiment, an amount of cerium ammonium nitrite solution having a mole concentration of 0.02M is stirred while an amount of urea is slowly added thereinto, so that the cerium ammonium nitrite solution in the mixture has a mole concentration about 0.16M. After stirring the mixture with a fixed revolving speed for a period of time, polystyrene nano particles are added into the mixture, and the pH value of the reaction solution is adjusted to be within the range from 2.0 to 5.3. Since the polystyrene nano particle having a pH value between 2.0 and 12.0 always has a negative Zeta potential, and the cerium oxide having a pH value between 2.0 and 5.3 has a positive Zeta potential, it is possible to control the pH value to the range between 2.0 and 5.3, and use the electrostatic attraction among the particles to produce a controlled assembly, so that a cerium oxide shell is formed on the polystyrene nano particles to produce the chemical mechanical polishing particles of the present invention. The concentration of salts should be watched in the process of synthesis, so as to enable the forming of a uniform shell and avoid undesired aggregation of particles.

After the production of chemical mechanical polishing particles, there are still unreacted ions remained in the reaction solution. Since the ion concentration is relatively high, a relatively thin electrical double-layer is existed among particles. Therefore, the synthesized chemical mechanical polishing particles have low stability, and it is necessary to separate the chemical mechanical polishing particles from most part of the reaction solution. To remove the ions from water, the chemical mechanical polishing particles are centrifugally separated using a centrifugal machine at a revolving speed of 4000 rpm for 10 minutes. After the centrifugal separation, the upper layer solution is dumped, and a corresponding volume of deionized water is added. The mixture is uniformly mixed using an ultrasonic oscillator. Finally, an adequate amount of surfactant is added into and uniformly mixed with the mixture to produce the chemical mechanical polishing slurry of the present invention. The surfactant may be SDS or other ionic surfactants.

A chemical mechanical polishing test is conducted on a wafer using the chemical mechanical polishing slurry produced in the above-described method. To prepare test wafer samples, p-type silicon in 150 mmφ and having the crystal face (100) is used. All the wafer samples are subjected to oxidization, diffusion, and low-pressure chemical vapor deposition (using ASM/LB45 Furnace System). First, 5000 Å of silicon oxide is grown on a silicon wafer substrate through wet oxidation using low-pressure chemical vapor deposition (LPCVD) to prepare a silica wafer, and a silicon nitride wafer is deposited on the silicon wafer substrate using LPCVD. Then, the chemical mechanical polishing is performed. Parameters used in the test are shown in the following Table 1.

TABLE 1

Parameter

| | Silicon Oxide or | Solid- | |
|---|---|---|---|
| | Silicon Nitride | Content | |
| Group | CMP | (%) | pH Value |
| 1 | Oxide | 0.108 | 4.4 |
| 2 | Oxide | 0.25 | 9.8 |
| 3 | Oxide | 0.13 | 9.8 |
| 4 | Oxide | 0.06 | 9.8 |
| 5 | Oxide | 0.21 | 11.0 |
| 6 | Oxide | 0.11 | 11.0 |
| 7 | Oxide | 0.06 | 11.0 |
| 8 | Oxide (D.I water) | 0.00 | 11.2 |
| 9 | Nitride | 0.19 | 10.0 |
| 10 | Nitride | 0.10 | 10.0 |
| 11 | Nitride | 0.05 | 10.0 |
| 12 | Oxide | 0.168 | 6.7 |
| 13 | Nitride | 0.168 | 6.7 |

Test analyses conducted after the CMP include film thickness measurement analysis, surface topography analysis, removal rate and non-uniformity analysis. In the film thickness measurement analysis, an n&k analyzer is used to measure the thickness of the silicon oxide film and of the silicon nitride film. Then, an atomic force microscopy is used to measure the surface roughness with a probe. Changes in the wafer samples after the polishing are measured at five points on each of the wafer samples, including a central point, and other four points separately located in an upper, a lower, a left, and a right portion of the wafer sample.

The removal rate is calculated using the following formula (1):

$$Removal Rate ( R . R . ) = \frac{( Pre \text{-} CMP Thickness ) - ( Post \text{-} CMP Thickness )}{Polish Time} \qquad ( 1 )$$

where,

Pre is the original wafer thickness;

Post is the wafer thickness after polishing;

CMP Thickness is the chemical mechanical polishing thickness; and

Polish Time is the total time for polishing.

The non-uniformity of the wafer after polishing is calculated using the following formula (2):

$$Non \text{-} Uniformity = \frac{Δ max - Δ min}{2 Δ mean}$$

Where,

Δ is the value of removed thickness divided by minutes (Å/min).

Data of removal rate and non-uniformity obtained from the CMP test are listed in the following Table 2.

TABLE 2

| | Non- | R.R Measured at Five Points on | | | | | |
|---|---|---|---|---|---|---|---|
| | uniformity | Wafer | | | | | Average R.R |
| Group | (%) | 1 | 2 | 3 | 4 | 5 | (Å/min) |
| 1 | 0.108 | 1 | 1 | 3 | 0 | 2 | 1.4 |
| 2 | 0.25 | 233 | 127 | 209 | 425 | 615 | 321.8 |
| 3 | 0.13 | 88 | 67 | 138 | 65 | 95 | 90.6 |
| 4 | 0.06 | 8 | 6 | 4 | 9 | 11 | 7.6 |
| 5 | 0.21 | 184 | 237 | 230 | 185 | 197 | 206.6 |
| 6 | 0.11 | 98 | 97 | 154 | 113 | 130 | 118.4 |
| 7 | 0.06 | 2 | 18 | 0 | 0 | 0 | 4 |
| 8 | 0.00 | 0 | 0 | 0 | 0 | 0 | 0 |
| 9 | 0.19 | 99 | 140 | 121 | 100 | 120 | 96 |
| 10 | 0.10 | 47 | 70 | 84 | 75 | 67 | 68.6 |
| 11 | 0.05 | 18 | 42 | 26 | 19 | 33 | 27.6 |
| 12 | 0.168 | 197 | 194 | 227 | 186 | 214 | 203.6 |
| 13 | 0.168 | 40 | 59 | 66 | 39 | 67 | 54.2 |

It is indicated in the test results the concentration and pH value of the particles in the polishing slurry are increased, and both of the silicon oxide layer and the silicon nitride layer tend to have an increased removal rate. For example, when the particle concentration is 0.25%, the removal rate is as high as 321.8 (Å/min).

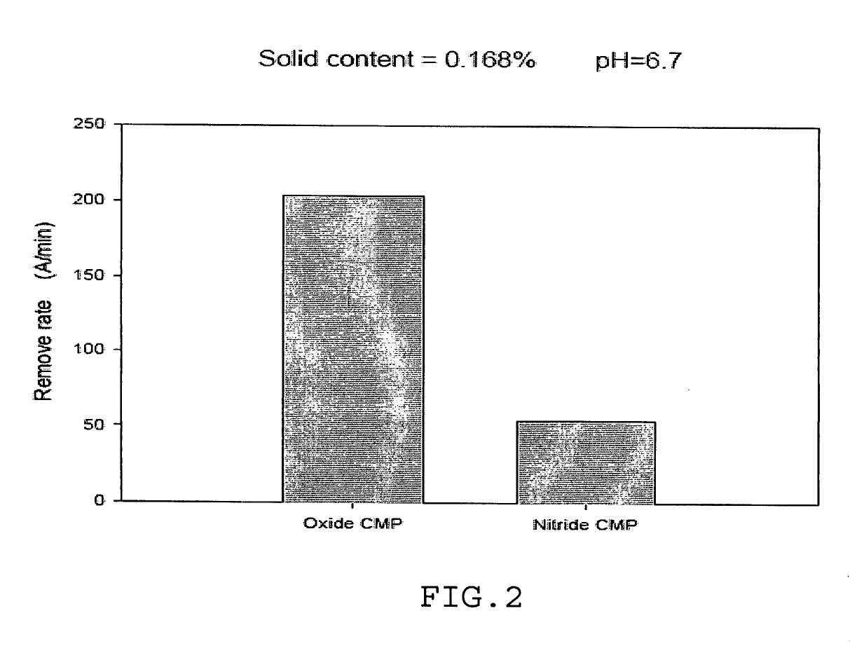

Please refer to FIG. 2 that is a graph showing a selection ratio of the CMP slurry of the present invention with respect to silicon oxide and silicon nitride. For silicon oxide layer and silicon nitride layer both having a pH value of 6.7 and a solid content of 0.168%, the CMP slurry of the present invention has a selection ratio as high as 4:1 with respect to the silicon oxide and the silicon nitride. In the surface topography analysis, it is found either the silicon oxide layer or the silicon nitride layer has a surface roughness between 0 and 1.3 nanometer (nm) after being polished using the CMP slurry of the present invention. This means the polished surface is considerably even without the problem of scratches.

In conclusion, in the present invention, organic nano particles are produced by way of organic polymerization and used to replace the inorganic polishing particles used in the conventional CMP process; the organic nano particles are employed in surface modification technique to achieve increased function; the CMP particle hardness is upgraded; and the polishing selection ratio is increased. The present invention also provides the following advantages:
1. The particle size is controllable to obtain high uniformity in particle size.
2. The organic particles have low density, and therefore have high stability and high dispersibility in a solution.
3. The organic particles are spherical in shape, and have some extent of elasticity to avoid scratching the wafer.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A chemical mechanical polishing particle, comprising:
an organic nano particle; and
a cerium oxide shell formed on an outer surface of said organic nano particle.

2. The chemical mechanical polishing particle as claimed in claim 1, wherein said organic nano particle is synthesized by way of emulsion polymerization.

3. The chemical mechanical polishing particle as claimed in claim 1, wherein said organic nano particle is a nano-scale polystyrene particle.

4. A method of producing chemical mechanical polishing particles, comprising the steps of:
putting a type of organic nanoparticles in a reaction solution containing nano-scale cerium oxide; and
assembling said nano-scale cerium oxide to outer surfaces of said organic nano particles to form chemical mechanical polishing particles.

5. The method of producing chemical mechanical polishing particles as claimed in claim 4, wherein said organic nano particles are synthesized by way of emulsion polymerization.

6. The method of producing chemical mechanical polishing particles as claimed in claim 4, wherein said organic nano particles are nano-scale polystyrene particles.

7. The method of producing chemical mechanical polishing particles as claimed in claim 4, wherein said reaction solution consists of urea and cerium ammonium nitrite solution.

8. The method of producing chemical mechanical polishing particles as claimed in claim 4, wherein said reaction solution has a pH value in the range between pH2.0 and pH5.3.

9. A chemical mechanical polishing slurry, comprising:
a plurality of chemical mechanical polishing particles, each of which includes an organic nano particle and a cerium oxide shell formed on an outer surface of said organic nano particle; and
a surfactant, in which said chemical mechanical polishing particles are dispersed.

10. The chemical mechanical polishing slurry as claimed in claim 9, wherein said organic nano particles are synthesized by way of emulsion polymerization.

11. The chemical mechanical polishing slurry as claimed in claim 9, wherein said organic nano particles are nano-scale polystyrene particles.

12. The chemical mechanical polishing slurry as claimed in claim 9, wherein said surfactant is an ionic surfactant.

13. The chemical mechanical polishing slurry as claimed in claim 12, wherein said ionic surfactant comprises sodium dodecyl sulfate.
